(19) United States
(12) Patent Application Publication
(10) Pub. No.: US 2005/0079319 A1
(43) Pub. Date: Apr. 14, 2005

(54) Velour material for electrophotographic apparatus

(75) Inventors: Yasuyuki Ohara, Nagoya-shi (JP); Toyohiro Kanzaki, Okazaki-shi (JP); Masaru Nakayama, Anjo-shi (JP); Hidetaka Yamauchi, Anjo-shi (JP)

Correspondence Address: POSZ & BETHARDS, PLC, 11250 ROGER BACON DRIVE, SUITE 10, RESTON, VA, 20190, US

(73) Assignee: TSUCHIYA TSCO CO., LTD.

(21) Appl. No.: 10/958,111

(22) Filed: Oct. 5, 2004

(30) Foreign Application Priority Data
Oct. 9, 2003 (JP) 2003-351249

(51) Int. Cl. B32B 33/00; D06L 1/00

(52) U.S. Cl. 428/96; 428/97; 8/137.5

(57) ABSTRACT

A velour material includes a base fabric comprised of a woven fabric and a plurality of pile yarns woven into the base fabric in a pile weave such that they are raised on the surface thereof. The pile yarn has been subjected to a cleaning treatment in which the pile yarn is washed in the raw yarn stage with a cleaning solution containing a surfactant and then the cleaning solution is removed with water. Fats and oils adhered to fibers of the pile yarn have been washed and removed by the cleaning treatment. The content of fats and oils in the pile yarn after the cleaning treatment is half or less compared to the content of fats and oils in the pile yarn before the cleaning treatment.

### BACKGROUND OF THE INVENTION

The present invention relates to a velour material used in an electrophotographic apparatus such as, for example, a cleaning brush for scraping and removing toner adhered to a photoreceptor drum, an electrifying brush for charging the surface of a photoreceptor drum, an antistatic brush for eliminating static electricity charged on a photoreceptor drum and the like.

Cleaning brushes using this type of velour materials have been known previously as shown below, for example, in Japanese Laid-Open Utility Model Publication No. 61-92968 and Japanese Laid-Open Patent Publication No. 2003-58013. In Japanese Laid-Open Utility Model Publication No. 61-92968, the surface of fibers in a velour material is washed in turn with a cleaning solution containing a surfactant as a main component and water, in a state where the velour material which is formed by implanting fibers on a base fabric is spirally wound on a core or in a state before the velour material is wound onto the core (a first prior example). As a result, fats and oils and the like adhered to the surface of fibers in the velour material are removed so as to suppress the adhesion of fats and oils and the like to the surface of a photoreceptor.

On the other hand, the velour material in Japanese Laid-Open Patent Publication No. 2003-58013 is composed of fibers which have been subjected to a finishing treatment using a water-miscible aliphatic organic compound containing a plurality of alcoholic hydroxy substituents (a second prior example). In this type of cleaning brushes, use of the aliphatic organic compound can suppress damage to the surface layer of a photoreceptor formed from polycarbonate resins.

However, in the first prior example, the surface of fibers in a velour material is cleaned after the velour material is manufactured. Therefore, the tip of each fiber is easy to clean, but the proximal end of each fiber, in particular, the part which is woven into a base fabric is difficult to clean. Thus, the fats and oils may be left behind on the surface of the proximal end. On the other hand, in the second prior example, the surface of fibers in a velour material is not cleaned, and a finishing agent (an aliphatic organic compound) is used that has the effect on suppressing damage to the surface layer of a photoreceptor. However, when the aliphatic organic compound is excessively used for the finishing treatment, the compound may adhere to the surface of a photoreceptor to swell the surface layer of the photoreceptor, causing chemical damage, such as cracks. This may cause defects in the images to be obtained.

### BRIEF SUMMARY OF THE INVENTION

The present invention has been created by focusing attention to the problems existing in the prior art. The object of the present invention is to provide a velour material for an electrophotographic apparatus which can suppress chemical damage on the surface of a photoreceptor and reduce the defects in images to be obtained.

In order to achieve the object, the present invention provides a velour material for an electrophotographic apparatus adapted to be in contact with the surface of a photoreceptor in an electrophotographic apparatus to which fine particles adhere. The velour material comprises a base fabric composed of a woven fabric and a plurality of raised materials which are raised on the surface of the base fabric and are in contact with the surface of the photoreceptor. At least one of fibers forming the woven fabric and fibers forming the raised material are those in which a finishing agent is removed from the surface of the fibers by subjecting them to the cleaning treatment with a cleaning solution containing a surfactant.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a velour material;

FIG. 2 is a front view showing a state of a cleaning brush being manufactured;

FIG. 3 is a schematic view showing an electrophotographic apparatus;

FIG. 4(a) is a perspective view showing a bobbin around which pile yarns are wound;

FIG. 4(b) is a partial side sectional view showing the bobbin in FIG. 4(a);

FIG. 5(a) is an image showing black parts in character pattern printing; and

FIG. 5(b) is an image showing void parts in solid printing.

### DETAILED DESCRIPTION OF THE PREFERRED EMBODIMENTS

An embodiment according to the present invention of a velour material for a cleaning brush in an electrophotographic apparatus will be described in detail below with reference to drawings.

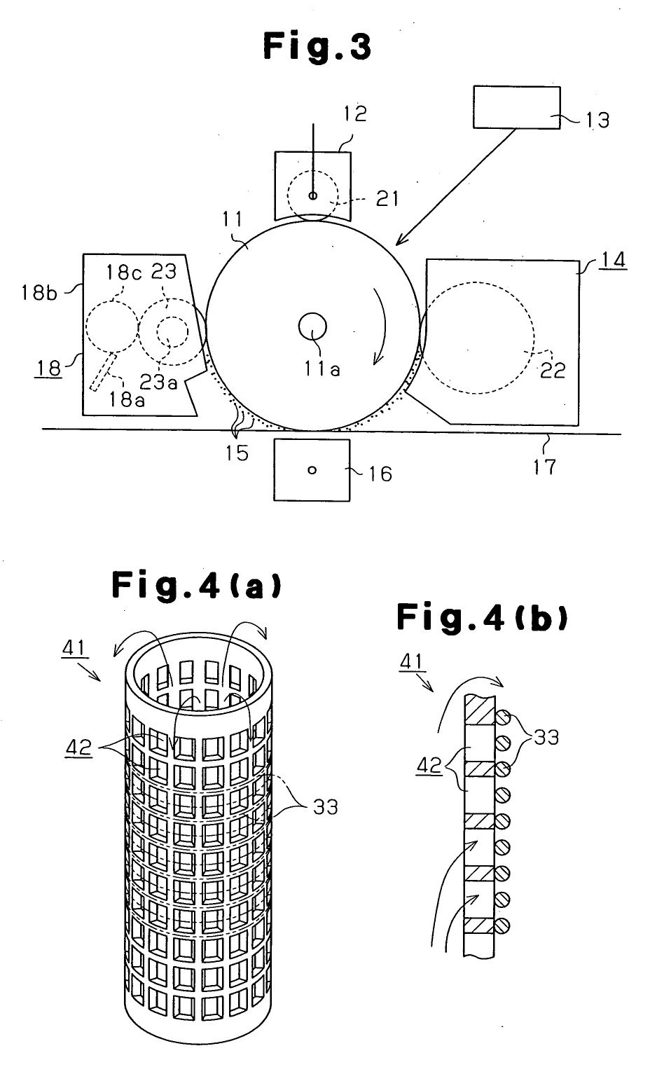

First, an electrophotographic apparatus and the function thereof will be described. As shown in FIG. 3, the electrophotographic apparatus comprises a photoreceptor drum 11, and further comprises an charging part 12, an exposure part 13, a development part 14, a transfer part 16 and a cleaning part 18 provided in the surroundings of the photoreceptor drum 11 in turn from above the photoreceptor drum 11 along the direction of rotation. The surface layer of the photoreceptor drum 11 is formed from a polycarbonate resin. This photoreceptor drum 11 is rotatably supported by a spindle 11a and is adapted to be chargeable on the surface thereof.

In a housing 18b for the cleaning part 18, a cleaning brush 23 is rotatably supported by a supporting shaft 23a in a state where the cleaning brush 23 is in contact with the surface of the photoreceptor drum 11. As shown in FIG. 2, the cleaning brush 23 is formed by spirally winding a velour material 31 around the surface of the supporting shaft 23a composed of a round bar made of metal such as aluminum and stainless steel. Adjacent to the cleaning brush 23, a collection roller 18c is rotatably supported such that it is pressed against the cleaning brush 23. A blade 18a is provided at a diagonally lower side of the collection roller 18c with the tip thereof in contact with the peripheral surface of the collection roller 18c.

The surface of the photoreceptor drum 11 is uniformly charged to a predetermined potential by bringing a roll-formed electrifying brush 21 into contact with the photoreceptor drum 11 during the rotation thereof. In addition, in the exposure part 13, an electrostatic latent image is formed on the surface of the photoreceptor drum 11. Then, at the development part 14, toner 15 as fine particles is supplied from a roll-formed development brush 22 to the surface of the photoreceptor drum 11 and the electrostatic latent image is developed by the toner 15 to form a visible image. At the transfer part 16, the visible image is then transferred to a recording paper 17 supplied between the photoreceptor drum 11 and the transfer part 16. As a result, the image is formed on the recording paper 17.

Then, at the cleaning part 18, the toner 15 adhered to the surface of the photoreceptor drum 11 is scraped and removed by bringing the cleaning brush 23 into contact with the surface of the photoreceptor drum 11. After this, the toner 15 scraped by the cleaning brush 23 is transferred from the cleaning brush 23 to the surface of the collection roller 18c, and then is scraped from the surface of the collection roller 18c by the blade 18a and collected in the housing 18b.

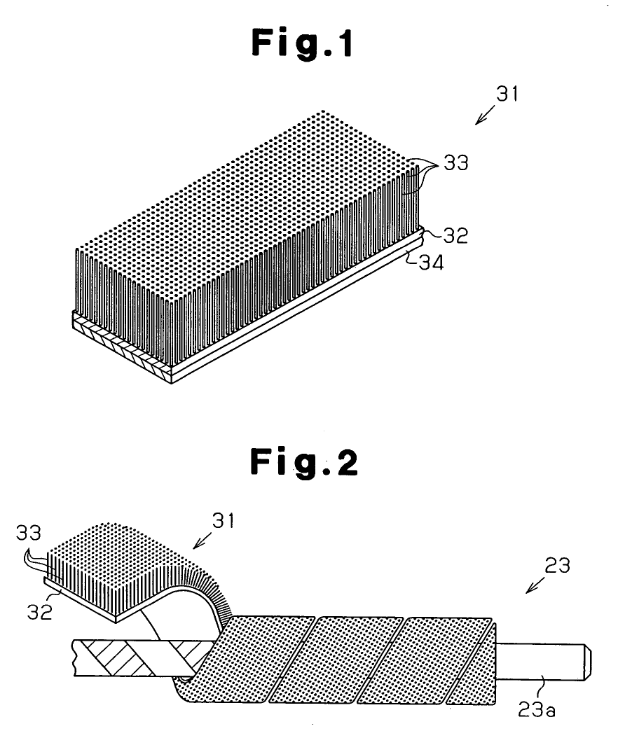

Next, a velour material 31 will be described. As shown in FIG. 1, the velour material 31 comprises a base fabric 32 composed of a woven fabric and pile yarns 33 as a plurality of raised materials. The pile yarns 33 are woven into the base fabric 32 in a pile weave such that they are raised on the surface thereof. A coating layer 34 made of a synthetic resin is provided on the back side of the base fabric 32. This coating layer 34 is formed from a coating agent composed of, for example, a rubber-based solvent type adhesive such as styrene-butadiene copolymer rubber, an adhesive resin such as an ethylene-vinyl acetate copolymer and polymethylmethacrylate, or a synthetic resin such as a polymeric emulsion. The coating agent is impregnated into the weave texture of the woven fabric forming the base fabric 32, thereby preventing fraying of the base fabric 32 and joining the proximal end of the pile yarns 33 to the base fabric 32.

The woven fabric forming the base fabric 32 is formed by weaving a plurality of yarns (warp and weft) (not shown) extending in directions orthogonal to each other. The pile yarns 33 are woven into the base fabric 32 such that they pass around interlaced yarns, the weft of the base fabric 32 being used as the interlaced yarns.

The pile yarn 33 is formed by twisting a plurality of fibers which have high durability and flexibility, excellent abrasion resistance and good sliding properties. These fibers include synthetic fibers made from acrylic resins, ultrahigh molecular weight polyethylene, polypropylene, polyamides, aramid resins, polyesters, nylon, polyethylene terephthalate, fluorocarbon polymers and the like, and semisynthetic fibers made from rayon and the like. In the present embodiment, synthetic fibers made from acrylic resins that are particularly excellent in durability among the above described polymers are preferably used.

The pile yarn 33 is subjected in the raw yarn stage to cleaning treatment with a cleaning solution containing a surfactant and water as a remover. The term “pile yarn 33 in the raw yarn stage” refers to the pile yarn 33, which is formed by twisting the plurality of fibers, in a state before the pile yarn 33 is woven into the base fabric 32. The cleaning treatment washes and removes fats and oils in finishing agents such as a binding agent, a lubricant and an antistatic agent adhered to fibers forming each pile yarn 33. As a result, the mass of fats and oils in the pile yarn 33 after the cleaning treatment (the fraction of fats and oils) is half or less compared to the mass of fats and oils in the pile yarn 33 before the cleaning treatment.

The cleaning solution used for the cleaning treatment is an aqueous surfactant solution with a concentration of 0.05 to 1% by mass. When the amount of the surfactant usage is less than 0.05% by mass, the action of washing and removing the fats and oils may be reduced. On the other hand, when it is higher than 1% by mass, the surfactant may remain on the surface of fibers forming the pile yarn 33, and this surfactant may adhere to the surface of the photoreceptor drum 11. As this type of cleaning solutions, those containing nonpolar solvents, for example, naphthenic, paraffinic and isoparaffinic solvents other than a surfactant may be used.

The surfactant includes a nonionic surfactant or an ionic surfactant that belongs to the same electrostatic charging series as the pile yarn 33. That is, a cationic surfactant is used for the pile yarn 33 formed from positively charged fibers and an anionic surfactant is used for the pile yarn 33 formed from negatively charged fibers. Consequently, a repulsive force works between the charged pile yarn 33 and the surfactant, thereby suppressing electrostatic adsorption of the surfactant to the surface of fibers forming the pile yarn 33.

Representative examples of the nonionic surfactants include ether-type nonionic surfactants, ester-type nonionic surfactants and the like. Representative examples of the ether-type nonionic surfactants include, for example, polyoxyethylene (hereinafter referred to POE) cetyl ether, POE stearyl ether, POE biphenyl ether, POE oleyl ether, POE lauryl ether, POE octyldodecyl ether, POE hexyldecyl ether, POE isostearyl ether, POE nonylphenyl ether, POE octylphenyl ether and the like.

Representative examples of the ester-type nonionic surfactants include, for example, POE sorbitan monooleate, POE sorbitan monostearate, POE sorbitan monopalmitate, POE sorbitan monolaurate, POE sorbitan trioleate, POE glycerin monostearate, POE glycerin monomyristate, POE sorbitol tetraoleate, POE sorbitol hexastearate, POE sorbitol monolaurate, POE sorbitol beeswax, polyethylene glycol monooleate, polyethylene glycol monostearate, polyethylene glycol monolaurate, lipophilic glycerin monooleate, lipophilic glycerin monostearate, self-emulsifiable glycerin monostearate, sorbitan monooleate, sorbitan sesquioleate, sorbitan trioleate, sorbitan monostearate, sorbitan monopalmitate, sorbitan monolaurate, sucrose fatty acid esters, decaglyceryl monolaurate, decaglyceryl monostearate, decaglyceryl monooleate, decaglyceryl monomyristate and the like.

Representative examples of cationic surfactants include, for example, quaternary ammonium salts such as alkyltrimethylammonium chlorides, lauryltrimethylammonium chloride, cetyltrimethylammonium chloride, stearyltrimethylammonium chloride, stearyltrimethylammonium bromide, lauryltrimethylammonium bromide, dialkyldimethylammonium chlorides and the like.

Representative examples of anionic surfactants include, for example, alkanesulfonates, alkyl sulfates, fatty acid salts, metallic soap, acyl glutamates, acyl methyltaurates, alkyl ether sulfates, POE lauryl ether phosphoric acid and salts thereof, triethanolamine dodecylbenzene sulfonate, sodium tetradecene sulfonate, dioctyl sodium sulfosuccinate and the like.

Alkanesulfonates include sodium dodecanesulfonate, sodium paraffin sulfonates having a carbon number of from 20 to 30 and the like. Alkyl sulfates include sodium lauryl sulfate, triethanolamine lauryl sulfate and the like. Fatty acid salts include coconut oil fatty acid potassium salt, coconut oil fatty acid triethanolamine, sodium laurate, potassium myristate, isopropanolamine myristate, sodium palmitate, sodium stearate, triethanolamine stearate, potassium oleate, sodium oleate and the like. Metallic soap includes magnesium stearate, calcium stearate, magnesium myristate and the like. Acyl glutamates include potassium cocoyl glutamate, triethanolamine cocoyl glutamate, triethanolamine lauroyl glutamate, potassium myristoyl glutamate, sodium stearoyl glutamate and the like. Acyl methyltaurates include potassium lauroyl methyltaurate, sodium cocoyl methyltaurate, sodium palmitoyl methyltaurate, sodium stearoyl methyltaurate and the like. Alkyl ether sulfates include sodium POE lauryl ether sulfate, triethanolamine POE lauryl ether sulfate and the like.

Next, a method for manufacturing a velour material 31 will be described.

When the velour material 31 is manufactured, a pile yarn 33 is first subjected to cleaning treatment. As shown in FIG. 4(a) in phantom lines, the pile yarn 33 in the raw yarn stage is wound around a circumferential wall of a bobbin 41, which is placed in a liquid tank (not shown). The bobbin 41 is cylindrical and has a plurality of water-flowing holes 42 formed on the circumferential wall thereof, forming a grid-like circumferential wall.

After the bobbin 41 is placed in a liquid tank, a cleaning solution is introduced into the liquid tank and heated to from 30° C. to 100° C. Then, as shown by arrows in FIG. 4(a), the pile yarn 33 is washed while circulating the cleaning solution from the inside of the bobbin 41 to the outside (cleaning step). At this time, as shown by arrows in FIG. 4(b), the part located outside the bobbin 41 of the pile yarn 33 wound around the circumferential wall of the bobbin 41 is washed with the cleaning solution, and at the same time the part of the pile yarn 33 located inside the bobbin 41 is brought into contact with the cleaning solution through the water-flowing holes 42 and is washed, thereby uniformly washing the pile yarn 33 all over.

When the temperature of the cleaning solution is lower than 30° C., the dispersibility of a surfactant in water is reduced, which leads to reduction of the affinity of the surfactant to fats and oils adhered to the fibers forming the pile yarn 33. This may insufficiently remove the fats and oils. On the other hand, when the temperature is higher than 100° C., the fibers forming the pile yarn 33 may be softened and deformed.

Next, the bobbin 41 after the cleaning step is placed in a separate liquid tank, and water at 100° C. or less is put into the liquid tank and circulated in the same manner as in the cleaning step. At this time, the cleaning solution adhered to the fibers forming the pile yarn 33 is removed (removing step). When the temperature of the water is higher than 100° C., the fibers forming the pile yarn 33 may be softened and deformed.

Subsequently, the pile yarn 33 after the cleaning step is put into a dryer (not shown) and dried at 30° C. to 100° C. (drying step). When the atmospheric temperature is lower than 30° C., the pile yarn 33 may be dried with difficulty. On the other hand, when the temperature is higher than 100° C., the fibers forming the pile yarn 33 may be softened and deformed.

Then, the velour material 31 is manufactured by weaving the pile yarns 33, which is already subjected to the cleaning treatment including the above described three steps, into the base fabric 32 in a pile weave such that they are raised on the surface of the base fabric 32.

The effect exerted by the above described embodiment will be described below.

The pile yarn 33 for the velour material 31 in the present embodiment is subjected to the cleaning treatment in which the pile yarn 33 in the raw yarn stage is washed with a cleaning solution containing a surfactant and then the solution is removed with water. Therefore, fats and oils on the surface of fibers forming the pile yarn 33 can be easily removed over a wide range, compared with the type in which the cleaning treatment of the velour material is conducted in the state where the velour material 31 is wound on a core or in a state before the velour material is wound onto the core. As a result, fats and oils on the surface of fibers forming the pile yarn 33 are effectively washed and removed, suppressing adhesion thereof to the surface of the photoreceptor drum 11. Thus, chemical damage on the surface of the photoreceptor drum 11 can be suppressed, thereby reducing defects in the resulting images.

In the cleaning treatment of the pile yarn 33, there is used a cleaning solution containing a nonionic surfactant or an ionic surfactant that belongs to the same electrostatic charging series as the pile yarn 33. This prevents adsorption of the surfactant to the charged pile yarn 33, preventing the surfactant from adhering to the surface of the photoreceptor drum 11. Thus, the chemical damage on the surface of the photoreceptor drum 11 can be suppressed, thereby securely reducing defects in the resulting images.

The cleaning treatment includes a cleaning step in which the pile yarn 33 is washed with a cleaning solution heated to 30° C. to 100° C. with a concentration of 0.05 to 1% by mass, a removing step in which the cleaning solution adhered to each pile yarn 33 is removed with water at 100° C. or less, and a drying step in which each pile yarn 33 is dried at 30° C. to 100° C. That is, fats and oils can be easily washed by using a cleaning solution which is set in a temperature range where the dispersibility of a surfactant in water and the action for washing fats and oils are improved. Thus, fats and oils adhered to the pile yarn 33 can be securely removed. In addition, use of the water with an appropriate temperature for the fibers forming the pile yarn 33 in the removing step allows the cleaning solution to be easily removed from the surface of fibers without changing the shape of the fibers.

The fraction of fats and oils in the pile yarn 33 after the cleaning treatment is half or less compared to the fraction of fats and oils in the pile yarn 33 before the cleaning treatment. This means that most of the fats and oils are removed by the cleaning treatment. As a result, the adhesion of fats and oils to the surface of the photoreceptor drum 11 can be securely suppressed, thereby securely suppressing the chemical damage on the surface of the photoreceptor drum 11.

The cleaning step of the cleaning treatment is designed to wash the pile yarn 33 by circulating the cleaning solution from the inside of the bobbin 41 to the outside. Consequently, the pile yarn 33 can be uniformly washed all over, thereby effectively removing fats and oils adhered to the fibers forming the pile yarn 33.

A binding agent as a finishing agent is removed by subjecting the pile yarn 33 to the cleaning treatment. The binding agent is used for enhancing ease of forming the pile yarn 33 by twisting a plurality of fibers. Since the pile yarn 33 is already subjected to the cleaning treatment in the raw yarn stage thereof, the binding agent can be removed over a wider range in each fiber and the binding between each fiber is more effectively eliminated than in the above described first prior example. As a result, the opening property of the fibers forming the pile yarn 33 is improved and each fiber is uniformly dispersed. Therefore, in the case where the velour material 31 of the present embodiment is used to scrape the toner 15 adhered to the surface of the photoreceptor drum 11, the tip of the pile yarn 33 is in uniform contact with the surface of the photoreceptor drum 11 when the pile yarn 33 is brought into contact with the surface of the photoreceptor drum 11. As a result, uneven wiping of the toner 15 can be effectively suppressed.

The present embodiment may also be embodied by modifying it as described below.

The cleaning treatment may be applied to the fibers in the stage before a plurality of fibers is twisted to form the pile yarn 33, that is, in the fiber stage.

The remover may be any remover that can remove the cleaning solution adhered to the fibers, and may include a lower alcohol such as methanol and ethanol. When water is used as a remover as in the present embodiment, the water may be any of pure water, tap water or ion-exchanged water. Preferably, it is appropriately selected depending on the situation, and pure water in which impurity content is suppressed is most preferably used.

The velour material 31 of the present embodiment exerts a desired function when the pile yarn 33 thereof is brought into contact with the surface of the photoreceptor drum 11. Therefore, the velour material 31 may be used, for example, as a charging brush for charging the surface of the photoreceptor drum 11 or an antistatic brush for removing static electricity charged on the photoreceptor drum 11. Since the velour material 31 has the pile yarn 33 with an improved opening property, uneven electrification and uneven static-elimination can be effectively suppressed.

The velour material 31 of the present embodiment may be used as a sealing material for sealing the leakage of the toner 15. Such a sealing material is provided, for example, between the housing composing the development part 14 and the development brush 22, thereby sealing the toner 15 leaking outside from the clearance between the development brush 22 and the housing.

Conductive fibers may be used as the fibers forming the pile yarn 33. The static electricity charged on the surface of the photoreceptor drum 11 is effectively conducted and discharged by bringing the pile yarn 33 made from conductive fibers into contact with the surface of the photoreceptor drum 11. Such a construction allows a better static-eliminating function to be exerted.

The conductive fibers and insulating fibers composed of chemical fibers may be blended for use as the fibers forming the pile yarn 33. The insulating fibers composed of chemical fibers include regenerated fibers such as rayon fibers and cuprammonium rayon fibers, and synthetic fibers made from acrylic resins, ultrahigh molecular weight polyethylene, polypropylene, polyamides, aramid resins, polyesters, nylon, polyethylene terephthalate and fluorocarbon polymers and the like. The blend of conductive fibers with insulating fibers reduces the amount of usage of expensive conductive fibers, thereby enabling reduction of the manufacturing cost.

The cleaning treatment may be applied to the fibers forming the woven fabric (base fabric 32) in addition to the pile yarn 33. This can effectively remove even fats and oils adhered to the fibers forming the base fabric 32. Therefore, the adhesion of fats and oils in the base fabric 32 to the surface of the photoreceptor drum 11 can be effectively suppressed even when the apparatus is constituted such that, for example, the base fabric 32 is brought into contact with the surface of the photoreceptor drum 11 because of the short length of the pile yarn 33, or fats and oils are evaporated from the base fabric 32. In such a case, the cleaning treatment may be applied only to the fibers forming the base fabric 32, without applying the cleaning treatment to the pile yarn 33.

The velour material 31 may be composed of the base fabric 32 using a base material comprising a film formed from synthetic resins such as polyesters, polypropylene, acrylics, nylon and urethanes, and the pile yarn 33. In this case, the pile yarn 33 is welded to the surface of the base fabric 32. This pile yarn 33 is already subjected to the cleaning treatment in the raw yarn stage or in the fiber stage.

### EXAMPLES

Next, the present invention will be described more specifically with reference to examples and comparative examples.

### Use Example 1

Acrylic synthetic fibers (Kanekaron available from Kaneka Corporation, formerly known as the Kanegafuchi Chemical Industry Co., Ltd.) were wound around the bobbin 41, and the fibers were washed for 60 minutes with an aqueous solution at 60° C. of polyoxyethylene cetyl ether (Scoreroll 700 Conc available from Kao Corporation) with a concentration of 0.2% by mass. Next, the aqueous solution of polyoxyethylene cetyl ether was removed with water at 60° C., the operation being repeated five times each for 10 minutes using fresh water each time. Subsequently, the fibers were dried in the atmosphere at 60° C. for 60 minutes. The acrylic synthetic fibers used in the present use example are negatively charged, and polyoxyethylene cetyl ether is a nonionic surfactant.

### Example 1

The velour material 31 using the fibers obtained in Use Example 1 as the pile yarn 33 was manufactured, and the velour material 31 was fixed to the photoreceptor drum (Drum cartridge DR-6000 available from Brother Industries, Ltd.) 11 such that the pile yarn 33 is in contact with the surface of the photoreceptor drum 11. Then, the velour material 31 was maintained in the atmosphere at a temperature of 50° C. and a humidity of 90% for 240 hours in the state where it was fixed to the photoreceptor drum 11.

### Comparative Example 1

The velour material 31 using the acrylic synthetic fibers (Kanekaron available from Kanegafuchi Chemical Industry Co., Ltd.), which were not subjected to the above described cleaning treatment, as the pile yarn 33 was manufactured, and the velour material 31 was fixed to the photoreceptor drum 11 such that the pile yarn 33 is in contact with the surface of the photoreceptor drum 11. Then, the velour material 31 was maintained in the atmosphere similar to that in Example 1 for 240 hours in the state where it was fixed to the photoreceptor drum 11.

Each of Example 1 and Comparative Example 1 as described above was evaluated for the items shown below in (1) to (3). The results are shown in Table 1.

(1) Defects in Images

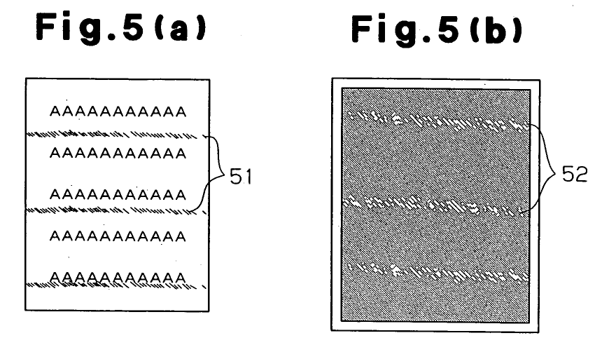

The velour material 31 was removed from the photoreceptor drum 11, and this photoreceptor drum 11 was used for character pattern printing and solid printing. Then, as shown in FIGS. 5(a) and 5(b), defects in images were evaluated by whether or not black parts 51 occurred in character pattern printing and whether void parts 52 occurred in solid printing. That is, they were rated on the following three scales: in the case neither black parts 51 nor void parts 52 were observed (good); in the case void parts 52 were not observed and black parts 51 were observed (fair); and in the case both black parts 51 and void parts 52 were observed (poor).

(2) Occurrence of Cracks in the Surface Layer of the Photoreceptor Drum

Microscopic observation was conducted on the surface of the photoreceptor drum 11 to which the pile yarn 33 has been in contact. The results were rated on the following two scales: in the case cracks did not occur (good); and in the case cracks did occur (poor).

(3) Fraction of Fats and Oils

The pile yarn 33 used in each of Example 1 and Comparative Example 1 was first put in a cylindrical filter paper, which was then mounted in a Soxhlet extractor. At this time, the mass of the cylindrical filter paper is represented by Dig, and the mass of the cylindrical filter paper containing the fibers is represented by D₂g. Then, extraction was performed for 3.5 hours with 300 ml of ethanol as an extraction solvent, and the resulting extraction solution was evaporated. The concentrated extraction solution was transferred to a 10 ml eggplant flask. Next, the concentrated extraction solution was dried under vacuum at about 100° C. for 3 hours, and then the eggplant flask containing fats and oils was weighed. At this time, the mass of the 10 ml eggplant flask is represented by W₁g, and the mass of the eggplant flask containing fats and oils is represented by W₂g. The fraction of fats and oils for each of Example 1 and Comparative Example 1 was calculated according to the following formula (1).
Fraction of fats and oils (% by mass)=(W₂−W₁)×100÷(D₂−D₁) (1)

TABLE 1

| | | Comparative |
|---|---|---|
| | Example 1 | Example 1 |
| Defects in images | good | fair |
| Occurrence of cracks | good | poor |
| Fraction of fats and | 0.16 | 0.56 |
| oils (% by mass) | | |

As shown in Table 1, the fraction of fats and oils in Example 1 in which the pile yarn 33 has been subjected in the raw yarn stage to the cleaning treatment using a cleaning solution containing a nonionic surfactant was reduced to about 30% compared to the fraction of fats and oils in Comparative Example 1 in which the pile yarn 33 is not subjected to the cleaning treatment. As a result, the occurrence of cracks on the surface of the photoreceptor drum 11 and the defects in images were suppressed.

Subsequently, each of Example 2 and Example 3 to be shown below was evaluated for the items (1) and (2) described above. The results are shown in Table 2.

### Use Example 2

Polypropylene fibers were wound around the bobbin 41, and the fibers were washed for 60 minutes with an aqueous solution at 50° C. of polyoxyethylene cetyl ether (Scoreroll 700 Conc available from Kao Corporation) with a concentration of 0.2% by mass. Next, the aqueous solution of polyoxyethylene cetyl ether was removed with water at 60° C., the operation being repeated four times each for 10 minutes using fresh water each time. Subsequently, the fibers were dried in the atmosphere at 50° C. for 60 minutes. The polypropylene fibers used in the present use example are negatively charged, and polyoxyethylene cetyl ether is a nonionic surfactant.

### Example 2

The velour material 31 using the fibers obtained in Use Example 2 as the pile yarn 33 was manufactured, and the velour material 31 was fixed to the photoreceptor drum (Drum cartridge DR-6000 available from Brother Industries, Ltd.) 11 such that the pile yarn 33 is in contact with the surface of the photoreceptor drum 11. Then, the velour material 31 was maintained in the atmosphere similar to that in Example 1 for 240 hours in the state where it was fixed to the photoreceptor drum 11.

### Use Example 3

Polypropylene fibers were wound around the bobbin 41, and the fibers were washed for 60 minutes with an aqueous solution (containing a paraffin sulfonate) at 50° C. with a concentration of 0.6% by mass. Next, the aqueous solution was removed with water at 60° C., the operation being repeated four times each for 10 minutes using fresh water each time. Subsequently, the fibers were dried in the atmosphere at 50° C. for 60 minutes. The polypropylene fibers used in the present use example are negatively charged, and the paraffin sulfonate is an anionic surfactant.

### Example 3

The velour material 31 using the fibers obtained in Use Example 3 as the pile yarn 33 was manufactured, and the velour material 31 was fixed to the photoreceptor drum (Drum cartridge DR-6000 available from Brother Industries, Ltd.) 11 such that the pile yarn 33 was in contact with the surface of the photoreceptor drum 11. Then, the velour material 31 was maintained in the atmosphere similar to that in Example 1 for 240 hours in the state where it was fixed to the photoreceptor drum 11.

TABLE 2

| | Example 2 | Example 3 |
|---|---|---|
| Defects in images | good | good |
| Occurrence of cracks | good | good |

As shown in Table 2, in Example 3 using a cleaning solution containing an ionic surfactant that belongs to the same electrostatic charging series as the fibers to be subjected to cleaning treatment, the surfactant was not adsorbed by the fibers during the cleaning treatment. As a result, the occurrence of cracks on the surface of the photoreceptor drum 11 and defects in images were suppressed.

Similar results were obtained in Example 2 in which the type of fibers forming the pile yarn 33 was changed from Example 1. As a result, it was possible to remove various surfactants adhered to a variety of fibers by the cleaning treatment in consideration of the electrostatic charging series of fibers, even when the surfactants to be used vary depending on the type of fibers to be used.

The present examples and embodiments are to be considered as illustrative and not restrictive and the invention is not to be limited to the details given herein, but may be modified within the scope and equivalence of the appended claims.

1. A velour material for use with a cleaning solution containing a surfactant and for an electrophotographic apparatus having a photoreceptor with a surface to which fine particles adhere, adapted to be in contact with the surface of the photoreceptor, said velour material comprising:
a base fabric including a surface and composed of a woven fabric formed from first fibers, and
a plurality of raised materials on the surface of said base fabric and being in contact with the surface of said photoreceptor, the raised materials being formed from second fibers,
wherein at least one of the first fibers forming said woven fabric and second fibers forming said raised material are substantially devoid of a finishing agent due to having been subjected to a cleaning treatment using the cleaning solution containing a surfactant.

2. The velour material for an electrophotographic apparatus according to claim 1, wherein said surfactant is a nonionic surfactant.

3. The velour material for an electrophotographic apparatus according to claim 1, wherein the first and second fibers include an electrostatic charging series and said surfactant is an ionic surfactant that belongs to the same electrostatic charging series as said fibers.

4. The velour material for an electrophotographic apparatus according to claim 1, wherein the second fibers forming said raised material are subjected to the cleaning treatment.

5. The velour material for an electrophotographic apparatus according to claim 4, wherein the second fibers forming said raised material are acrylic synthetic fibers and said surfactant is polyoxyethylene cetyl ether.

6. The velour material for an electrophotographic apparatus according to claim 4, wherein the second fibers forming said raised material are polypropylene fibers and said surfactant is polyoxyethylene cetyl ether.

7. The velour material for an electrophotographic apparatus according to claim 4, wherein the second fibers forming said raised material are polypropylene fibers and said surfactant is a paraffin sulfonate.

8. The velour material for an electrophotographic apparatus according to claim 4, wherein the mass of the finishing agent is extracted by a Soxhlet extraction method with ethanol in the raised material after said cleaning treatment is half or less of the mass of the finishing agent extracted by a similar method in the raised material before said cleaning treatment.

9. A velour material for use with a cleaning solution containing a surfactant and for an electrophotographic apparatus having a photoreceptor with a surface to which fine particles adhere, adapted to be in contact with the surface of the photoreceptor, said velour material comprising:
a base fabric including a surface and composed of a synthetic plastic; and
a plurality of raised materials on the surface of said synthetic plastic and are in contact with the surface of said photoreceptor, the raised materials being formed from fibers having surfaces,
wherein the fibers forming the raised material are substantially devoid of a finishing agent on the surfaces thereof due to the fibers having been subjected to a cleaning treatment using the cleaning solution containing a surfactant.

10. The velour material for an electrophotographic apparatus according to claim 1, wherein the raised material includes a raw yarn stage and a fiber stage and said cleaning treatment is applied to the raised material in the raw yarn stage or in the fiber stage.

11. A method for manufacturing a velour material for an electrophotographic apparatus including a photoreceptor with a surface to which fine particles adhere, and a base fabric with a surface and formed of a woven fabric and a plurality of raised materials on the surface of said base fabric and formed of fibers having surfaces, adapted to be in contact with the surface of the photoreceptor, said method comprising:
cleaning the raised material with a cleaning solution heated to 30° C. to 100° C. and containing a surfactant with a concentration of 0.05% to 1% by mass in order to remove a finishing agent from the surface of fibers forming said raised material,
removing cleaning solution adhered to the surface of the fibers with a remover at 100° C. or less, and
drying the fibers at 30° C. to 100° C.

12. The method for manufacturing a velour material for an electrophotographic apparatus according to claim 11, further comprising weaving said raised material into the surface of the base fabric after said drying step to form the velour material.

13. The method for manufacturing a velour material for an electrophotographic apparatus according to claim 11, wherein the raised material is wound around a bobbin having an inside and outside, and said cleaning is performed by circulating the cleaning solution from the inside to the outside of the bobbin around which the raised material is wound.
